(19) United States
(12) Patent Application Publication
(10) Pub. No.: US 2011/0125754 A1
(43) Pub. Date: May 26, 2011

(54) Reverse Dynamic Filter-Linked Pages System And Method

(75) Inventors: Andrew Shirey, San Francisco, CA (US); Robyn Battle, Oakland, CA (US)

(73) Assignee: CBS INTERACTIVE INC., Wilmington, DE (US)

(21) Appl. No.: 12/818,135

(22) Filed: Jun. 17, 2010

Related U.S. Application Data
(60) Provisional application No. 61/263,277, filed on Nov. 20, 2009.

(51) Int. Cl. G06F 17/30; G06F 17/00

(52) U.S. Cl. 707/740; 715/205; 707/741; 707/758; 707/E17.002; 707/E17.089

(57) ABSTRACT

Systems and methods for linking to attribute or category pages from a product landing page are described. The landing pages are dynamic filter linked pages (DFLL). Reverse DFLL links specifications in the product landing page back to a result set for an attribute or category using the links. An index builder (one for each category) analyzes the product record data to identify the entire set of values for a category. The index builder then generates category metadata based on this analysis that identifies all of the values within an attribute and/or category. When a request for a particular page is received by the web application, the reverse DFLL links are created for that product page (i.e., the links are created in real time). The specification values for the requested product are compared to the category metadata. If a match is identified, a link is created for that specification in the product landing page that links back to the attribute or category.

### STATEMENT OF RELATED APPLICATION

The present application claims the benefit of priority based on U.S. Provisional Patent Application Ser. No. 61/263,277, filed on Nov. 20, 2009, in the name of inventors Andrew Shirey, and Robyn Battle, entitled “Reverse Dynamic Filter-Linked Pages System And Method,” all commonly owned herewith.

### TECHNICAL FIELD

The present disclosure relates generally to a reverse dynamic filter-linked pages system and method.

### BACKGROUND

Many websites are configured as online catalogs which act as alternatives to traditional paper catalogs and offer enhanced navigational features as well as the advantages of broad, easy distribution. With the advent and increasing popularity of the Internet, suppliers have access to a much larger customer base. Through the Internet, the market base of manufacturers and resellers may be maximized while the associated overhead may potentially be drastically reduced. If an electronic catalog is well-organized and presented, it can help consumers to make good purchasing decisions by providing extensive information about the products they contain in an easy-to-navigate manner. Such a catalog either allows the consumers to gain information about products they will purchase elsewhere or to make purchases within the site itself.

However, perusing the sheer number of products available in the electronic catalog may be a daunting task for the consumer. For example, if a consumer chooses a product category (e.g. LCD Television) and chooses a value of a product attribute in the category (e.g. 40 inch monitor), the consumer may be provided with a large number of products (e.g. 40 inch LCD televisions). Considering that the user may be required to click back and forth among different Web pages to see the different 40 inch LCD televisions that are available, the shopping experience quickly becomes cumbersome and time consuming.

What is needed is a system and method which identifies a user selected value of a product attribute and selects the products in that category which have that selected value and provide a link to those products which is displayed on the product page being viewed by the user.

### OVERVIEW

In an aspect, a computer-implemented method comprises receiving a request for a web page associated with a product, wherein the product is assigned to a category. The method includes identifying at least one value associated with the product and comparing the at least one value for the product with a plurality of values associated with other products in the category. In the method, if the at least one value for the product matches the plurality of values associated with the category, then the method creates a link to a web page for the category in the web page associated with the product. The method delivers the web page for the other product that includes the link to the web page for the category.

In an aspect, a computer readable media, having instructions stored thereon, wherein the instructions, when executed by a computer processor, causes the computer processor to perform a method. The method comprises receiving a request for a displayed web page associated with a product, wherein the product is assigned to a category. The method includes identifying at least one value for the product and comparing the at least one value for the product with a plurality of values associated with the category. The method includes creating a link to an associated web page for the category in the web page associated with the product when the at least one value for the product matches the plurality of values associated with the category; and delivering the associated web page for the product that includes the link to the web page for the category.

In an aspect, a computer implemented system comprises a web layer, implemented by one or more processors, which receives a request for a displayed web page associated with a product, wherein the product is assigned to a category. The system includes a category index builder that is configured to identify at least one value for the product, wherein the category index builder compares the at least one value for the product with a plurality of values of other products associated with the category. The system includes an application programming interface that is configured to create a link to an associated web page for the category in the web page associated with the product when the at least one value for the product matches the plurality of values associated with the category. The application programming interface delivers the associated web page for the product that includes the link to the web page for the category.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 illustrates an example computer architecture in accordance with an aspect of the present disclosure;

FIG. 2 illustrates a detailed illustration of a category index builder in accordance with an aspect of the present disclosure;

FIG. 3 illustrates functional block diagram of the present system in accordance with an aspect of the present disclosure;

FIG. 4 illustrates a product landing page request process in accordance with an aspect of the present disclosure;

FIG. 5 illustrates a product landing page request process in accordance with an aspect of the present disclosure;

FIG. 6 illustrates a flowchart for creating a suggested terms database in accordance with an aspect of the present disclosure; and

FIG. 7 illustrates an example of a product landing Web page including DFLL links in accordance with an aspect of the present disclosure.

### DETAILED DESCRIPTION OF THE PREFERRED EMBODIMENT

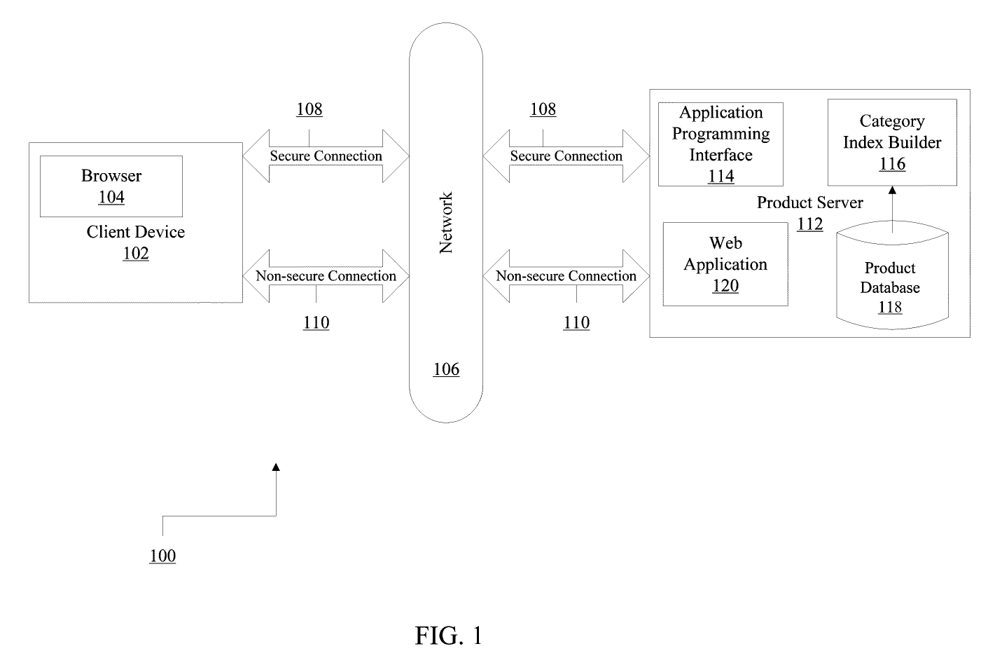

A preferred embodiment of a computer architecture in accordance with an aspect of the present disclosure is illustrated in FIG. 1. Reverse dynamic filter-linked pages system 100 includes one or more client computer 102 which executes a browser application 104 that supports the HTTP protocol, or other appropriate protocols. Client computer 102 is connected, typically through an ISP (Internet Service Provider), to Network 106 (such as the Internet) serving as a communication channel. For example, client computer 102 can be coupled to the ISP through a broadband connection such as ISDN (Integrated Services Digital Network), a cable modem, or a DSL (Digital Subscriber Line) connection. Product server 112 is also coupled to the Network 106 in a known manner. Product server 112 executes, for example, a web application 120, known as an HTTP server application, stored in a memory device (not shown). For example, public domain web server software applications from NCSA or APACHE can be used.

In the preferred embodiment, both of the client computer 102 and the product server 112 can be capable of communicating using a secure connection protocol, such as SSL or S-HTTP. For clarity, non-secure connections 110 and secure connections 108 are illustrated separately. However, typically, these connections will be effected over the same physical connection or communication channel, such as Network 106. Further, product server 112 can have many product landing pages stored in memory devices thereof, such as HTML format and/or other formats. Product server 112 also includes a product database 118 stored in the memory device thereof as described in detail below. Product database 118 stores product record data for at least one product. Product record data may include a product's price, type, dimensions, weight, material, color, display type, sound output, accessories, operating system, and manufacturer, among other things.

Client computer 102 can request a display of a product web page from the product server 112 by issuing a URL request via the network 106 to the product server 112. For example, a user of the client computer 102, i.e., a searcher, can enter a product query, including at least one product term(s), into a form page displayed by the browser 104. The browser interface can be populated with suggested product landing pages that are based on the product term from the product database 118. The user can then select a product landing page to be viewed. Once the product landing page is selected by the user, the application programming interface 114 requests that particular product landing page, and one or more reverse DFLL links are created for that product landing page. In one example, the reverse DFLL links are created in real time.

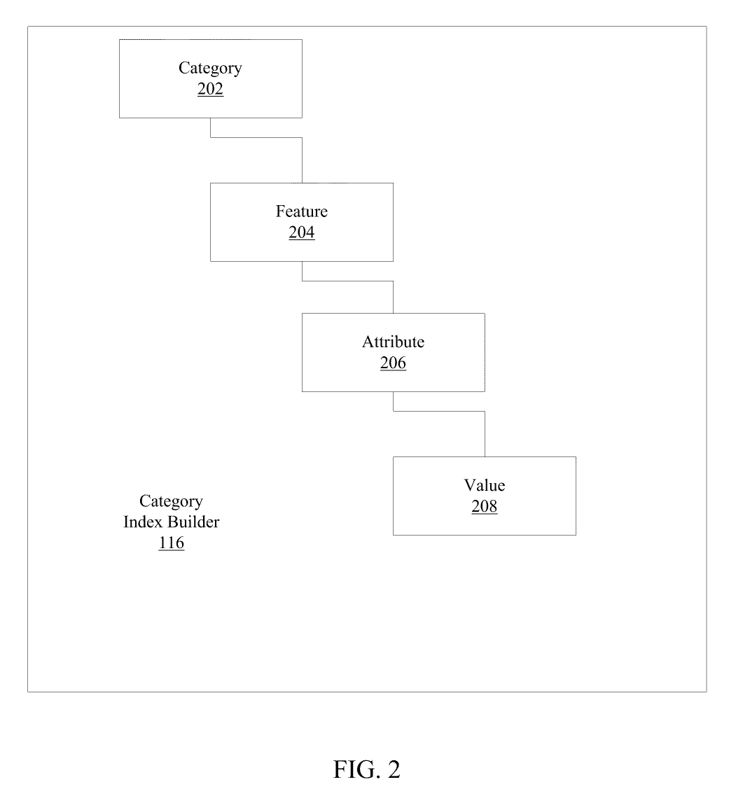

Product server 112 executes, for example, an application programming interface (API) 114 that requests one or more product landing pages once the web application 120 has received a request for a product landing page. Product server 112 also includes at least one category index builder 116 that analyzes product record data stored in the product database 118 to identify the entire set of values for a category based on a comparison of the values. Category index builder 116 pulls the product record data and then generates category metadata based on this analysis that identifies all of the values within an attribute and/or category. For instance, a value of a product may be include the size of the product's display screen. A more detailed illustration of the category index builder 116 can be seen in FIG. 2.

As shown in FIG. 2, the category index builder 116 maps to a distinct value 208 of a product, by way of mapping to a feature 204 and an attribute 206 of the product, the category 202 is mapped to at least one value of a product. There is only one category index builder 116 built for each category, and the category index builder converts individual product values into a set. The category index builder 116 defines the value sets.

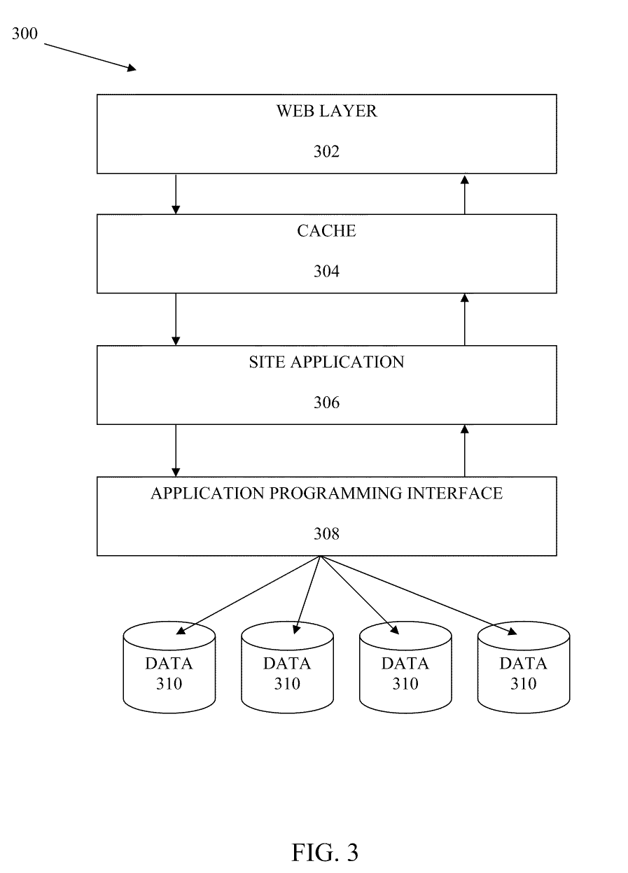

A functional illustration of the computer architecture in accordance with an aspect of the present disclosure is depicted in FIG. 3. System architecture 300 includes a web layer 302, a cache 304, a site application 306, a application programming interface 308, and a plurality of data stores 310. However, as is understood, the system architecture 300 may vary from the illustrated architecture. For example, web layer 302 may directly access data stores 310, the site application 306 may directly access data stores 310, the system architecture 300 may not include cache 304, etc., as will be appreciated by those skilled in the art. Web layer 302 is configured to receive user requests to access content through a web browser and return content that is responsive to the user request. Web layer 302 communicates the user requests to the cache 304. Cache 304 is configured to temporarily store content that is accessed frequently via the Web layer 302 and can be rapidly accessed by the Web layer 302. In one embodiment, the cache 304 may be a caching proxy server. Cache 304 communicates the user requests to site application 306.

Site application 306 is configured to update the cache 304 and process user requests received from the Web layer 302. Site application 306 may identify that the user request is for a web page that includes data from multiple sources. Site application 306 can then convert the page request into one or more requests for content from multiple sources and transmit these requests to application programming interface 308. Application programming interface 308 is configured to simultaneously access data from the plurality of data stores 310 to collect the data in response to the plurality of requests from the site application 306. The plurality of data stores 310 may include, for example, catalogue data about different product types (e.g., product specifications, pricing, images, etc.), content components, and the like. It will be appreciated that only one data store 310 may be provided to store the data.

The data in the data stores 310 is provided to application programming interface 308, which provides the content to the site application 306. Site application 306 then updates cache 304 and delivers the cached content in combination with the accessed content to the web layer 310. The web layer delivers browseable content to the user, such as through a product landing page.

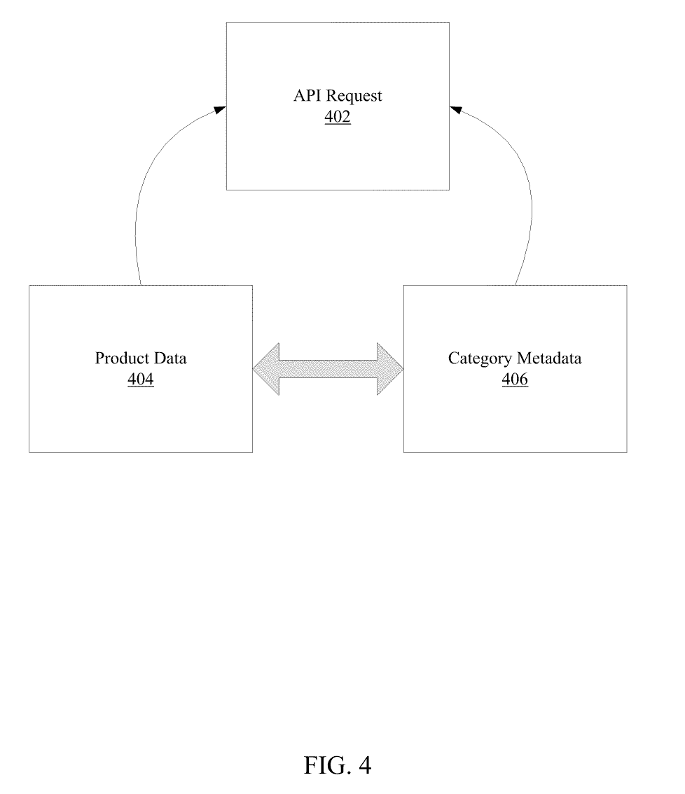

FIG. 4 illustrates a product landing page request process in accordance with an aspect of the present disclosure. As seen in FIG. 4, after the API requests a product landing page 402, the API receives all of the product data 404, (e.g. values and attributes), and the preexisting category metadata 406, which helps to structure the attributes and values. Thus, when the API receives a product page request for an individual product, the API only knows the values, and it doesn't know names of the attributes, sequences, categories, etc. Category metadata 406, which is preexisting, adds an extra layer of awareness behind the product landing page.

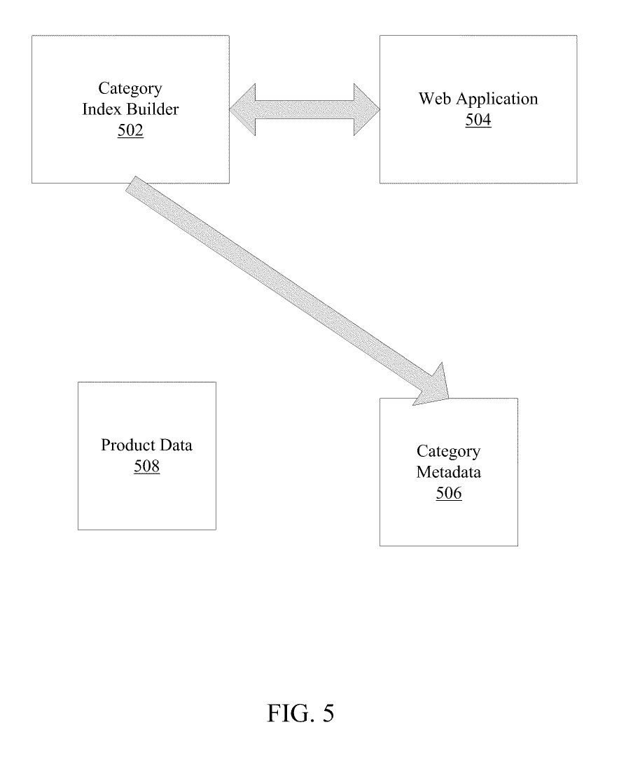

FIG. 5 illustrates a product landing page request process in accordance with an aspect of the present disclosure. As seen in FIG. 5, the category index builder 502 produces a category metadata database 506, which is based on all of the product data 508, and is gathered from the web application 504.

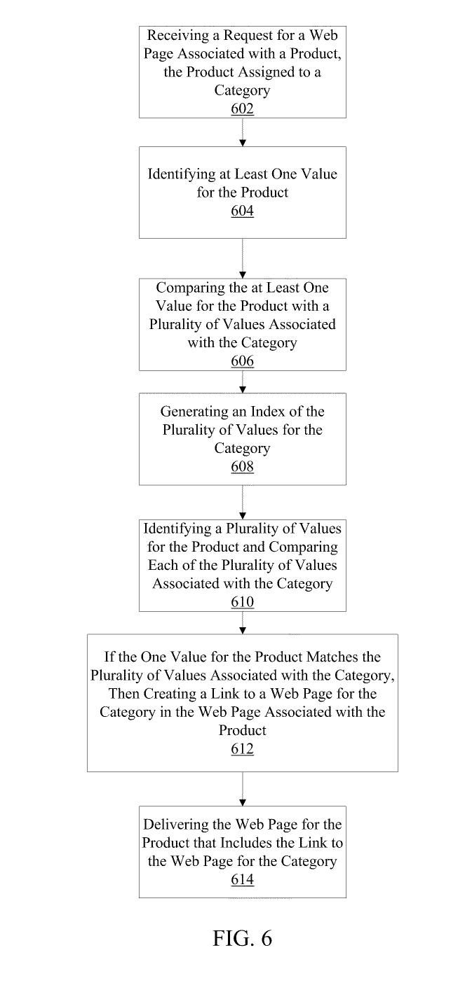

FIG. 6 illustrates a flowchart for creating a suggested terms database in accordance with an aspect of the present disclosure. Each step of FIG. 6 will be described in greater detail below. In step 602 a request for a web page associated with a product, the product assigned to a category is received. Next, in step 604 at least one value for the product is identified. Step 606 compares the at least one value for the product with a plurality of values associated with the category. Then, in step 608 an index of the plurality of values for the category is generated. Step 610 identifies a plurality of values for the product and compares each of the plurality of values associated with the category. After which, in step 612, if the one value for the product matches the plurality of values associated with the category, then a link to a web page for the category in the web page associated with the product is created. The web page for the product that includes the link to the web page for the category is delivered in step 614.

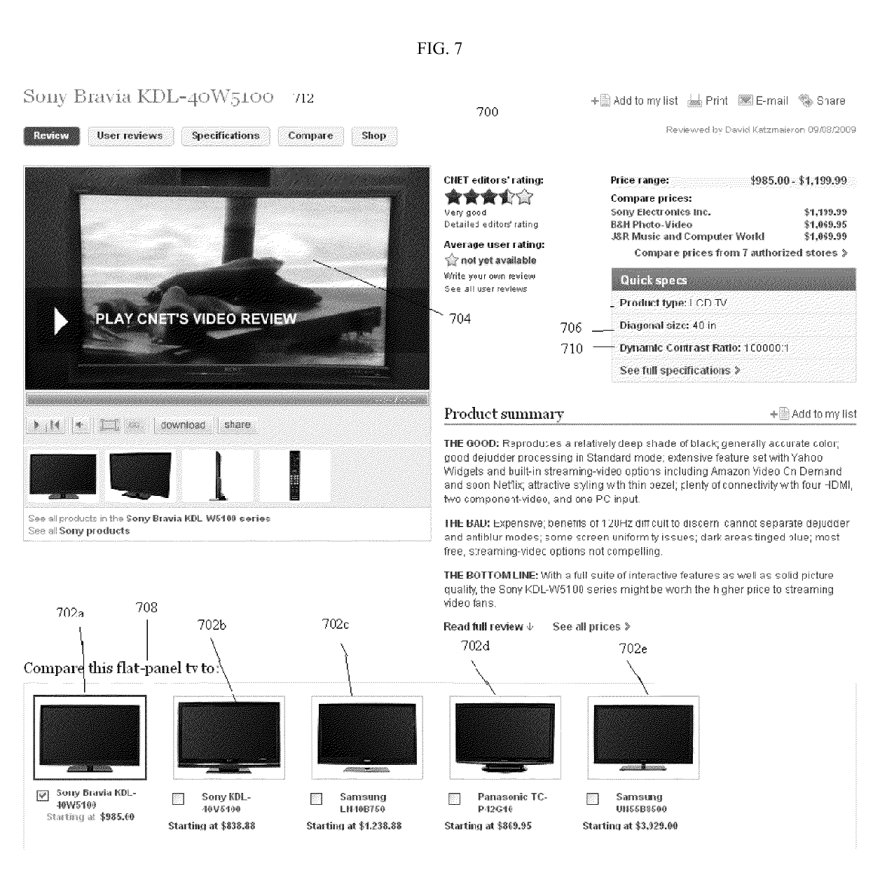

An example of a product landing page including DFLL links is illustrated in FIG. 7. The product landing page 700, in this specific example, is a product review page for a 40 in. Sony® Bravia® LCD display, which is the product 712. The DFLL links 702a-702e are seen at the bottom of the page, and link to other flat screen displays with a similar same screen size. In the instant case, the DFLL links to various products by various manufacturers.

In FIG. 7, the “category” level 708 is “flat screen tv”. Further, a 40 inch screen size would be the “value” 706, and display would be the feature 704. The “attributes” of this particular flat screen display could be other types of specifications for the display, for instance the dynamic contrast ratio 710.

Thus, the above described method and apparatus in accordance with the present disclosure provides a very effective method for providing reverse dynamic filter-linked pages. As can now be fully appreciated, the present system and method facilitates the enhancement of product searching by presenting a user with links to other products that have similar values as the product in the product landing page the user is currently viewing. The category indexer allows products under the same category umbrella to include links to product landing pages of products having similar values, thereby facilitating a more efficient and useful search to the user.

The present system and method facilitates enhanced on-line searching by suggesting terms correlated to a query term and stored in a suggested terms database. The invention can be implemented over any type of communications channel, such as the Internet, a local area network (LAN), a wide area network (WAN), direct computer connections, or the like, using any type of communication hardware and protocols. Any type of hardware or combination of hardware can be used for various clients and servers. Accordingly, the term “computer” as used herein, refers to any type of computing device or data terminal, such as a personal computer, a portable computer, a dumb terminal, a thin client, a hand held device or any combination of such devices. The various clients and servers can be a single computer at a single location or multiple computers at a single or multiple locations. For example, a server may be comprised of a plurality of redundant computers disposed in co-location facilities at various locations to facilitate scalability. Any appropriate server or client software can be used and any communication protocols can be used. Communication can be accomplished over electric cable, fiber optic cable, any other cable, or in a wireless manner using radio frequency, infrared, or other technologies. Any interface can be used for selecting products for purchase. The various information can be stored in any format and thus the term “database” as used herein refers to any collection of information such as a database file, a lookup table, or the like.

The invention has been described through a preferred embodiment. However, various modifications can be made without departing from the scope of the invention as defined by the appended claims and legal equivalents.

What is claimed is:

1. A computer-implemented method comprising:
receiving a request for a web page associated with a product, the product assigned to a category;
identifying at least one value associated with the product;
comparing the at least one value for the product with a plurality of values associated with other products the category;
if the at least one value for the product matches the plurality of values associated with the category, then creating a link to a web page for the category in the web page associated with the product; and
delivering the web page for the other product that includes the link to the web page for the category.

2. The method of claim 1, further comprising generating an index of the plurality of values for the category.

3. The method of claim 2, wherein a separate index is generated for each category.

4. The method of claim 1, wherein the plurality of values associated with the category are stored as category metadata.

5. The method of claim 1, wherein the category comprises at least one attribute and the at least one attribute comprises the plurality of values.

6. The method of claim 5, wherein if the at least one value for the product matches the plurality of values associated with the attribute, then creating a link to a web page for the attribute in the web page associated with the product

7. The method of claim 1, further comprising identifying a plurality of values for the product and comparing each of the plurality of values with plurality of values associated with the category.

8. Computer readable media, having instructions stored thereon, wherein the instructions, when executed by a computer processor, causes the computer processor to perform a method comprising:
receiving a request for a displayed web page associated with a product, wherein the product is assigned to a category;
identifying at least one value for the product;
comparing the at least one value for the product with a plurality of values associated with the category;
creating a link to an associated web page for the category in the web page associated with the product when the at least one value for the product matches the plurality of values associated with the category; and
delivering the associated web page for the product that includes the link to the web page for the category.

9. Computer readable media of claim 8, wherein the method further comprises generating an index of the plurality of values for the category.

10. Computer readable media of claim 9, wherein a separate index is generated for each category.

11. Computer readable media of claim 8, wherein the plurality of values associated with the category are stored as category metadata.

12. Computer readable media of claim 8, wherein the category further comprises at least one attribute and the at least one attribute comprises the plurality of values.

13. Computer readable media of claim 12, wherein the method further comprises creating a link to another associated web page for the attribute in the web page associated with the product when the at least one value for the product matches the plurality of values associated with the attribute.

14. Computer readable media of claim 8, wherein the method further comprises identifying a plurality of values for the product and comparing each of the plurality of values with the plurality of values associated with the category.

15. A computer implemented system comprising:
a web layer, operated by one or more processors, which receives a request for a displayed web page associated with a product, wherein the product is assigned to a category;
a category index builder configured to identify at least one value for the product, wherein the category index builder compares the at least one value for the product with a plurality of values of other products associated with the category;
an application programming interface configured to create a link to an associated web page for the category in the web page associated with the product when the at least one value for the product matches the plurality of values associated with the category, wherein the application programming interface delivers the associated web page for the product that includes the link to the web page for the category.

16. The system of claim 15, wherein the category index builder generates an index of the plurality of values for the category.

17. The system of claim 16, wherein the category index builder generates a separate index for each category.

18. The system of claim 15, wherein the plurality of values associated with the category are stored as category metadata.

19. The system of claim 15, wherein the category comprises at least one attribute and the at least one attribute comprises the plurality of values.

20. The system of claim 19, wherein the application programming interface creates a link to another associated web page for the attribute in the web page associated with the product when the at least one value for the product matches the plurality of values associated with the attribute.

21. The system of claim 15, wherein the category index builder identifies a plurality of values for the product and compares each of the plurality of values with the plurality of values associated with the category.
